(19) United States
(12) Patent Application Publication
(10) Pub. No.: US 2006/0130239 A1
(43) Pub. Date: Jun. 22, 2006

(54) Bed side rail method and apparatus

(76) Inventor: Robyn Smith, Shoreline, WA (US)

Correspondence Address: PERKINS COIE LLP;PATENT-SEA, P.O. BOX 1247, SEATTLE, WA, 98111-1247, US

(21) Appl. No.: 11/184,561

(22) Filed: Jul. 18, 2005

Related U.S. Application Data
(60) Provisional application No. 60/588,678, filed on Jul. 16, 2004.

(51) Int. Cl. A61G 7/053; A47C 31/00

(52) U.S. Cl. 5/662

(57) ABSTRACT

A bedside support device having a free swinging mode of a handle member where the handle member is positioned in a manner to prevent entrapment zones while in a free swinging mode to prevent injury to the individual in requirement of support. The bedside support device is adapted to resist vertical force placed thereon to give vertical support to an individual while allowing the handle region to reposition laterally to allow the individual to move to and from the bed structure. The handle region defined an unobstructed side region to allow the individual's legs to be placed under the handle member to properly allow the individual to stand up or sit down on the bed structure in a controlled and safe manner.

### RELATED APPLICATIONS

This application claims priority benefit of U.S. Ser. No. 60/588,678, filed Jul. 16, 2004.

### BACKGROUND OF THE INVENTION

As our population ages and individuals are subjected to trauma, limiting their mobility, there is an ever-present need for providing individuals with a certain amount of mobility support in their daily living. A good portion of our lives is spent resting and such time is often spent in our bed either sleeping or perhaps bedridden due to an injury or illness.

To aid individuals in need, various types of rails have been in production offering some form of assistance or containment within a bed in the home as well as in medical institutions such as hospitals.

It is important to understand the dynamics of providing assistance to individuals in need of support getting in and out of bed. In certain cases, the individual may be somewhat cognitively impaired such as in the case with an elderly patient suffering from dementia. With any form of cognitive impairment or even certain physical disabilities, there is a risk that the individual may fall off the lateral portion of the bed. If the individual is inadvertently pinched or stuck between any kind of support member, the individual may suffer severe injury or even death by way of suffocation. These entrapment issues are potentially lethal and many individuals do not have around the clock supervision and of course have a certain amount of privacy while in bed. Further, when an individual is in a trap position they may not have the mental or physical ability to call for help or press any type help call indicator to alert the nurse or caregiver.

In general, the activities of daily living relate around bed mobility which includes eating, dressing, grooming, toileting (bedside commode), bathing, and transfer to and from the bed and other functional tasks.

Therefore, under current FDA guidelines, there is a strong demand for providing a system that eliminates entrapment zones that can occur with various prior art devices. Approximately 575 entrapment reports have been received over a period of 19 years from Jan. 1, 1985, to Jan. 1, 2004. At least 575 reports, with 358 deaths, 111 injuries and 106 near misses with no injury. These entrapment events have occurred in openings between the bed rails, between the bed rail and mattress, under bed rails, between split rails, and between the bed rail and the head or foot boards. The population group that was most at risk were the frail, confused, restless or those with uncontrollable body movements. Such entrapment can occur in all patient care settings such as hospitals, nursing homes and well as private homes.

The population that would benefit from this invention are those individuals at risk for becoming entrapped in traditionally designed “side rails” that are attached to the length-wise portion of the bed frame. Many prior art designs were intended to prevent patients and/or elderly clients from falling out of bed. With the increased risk of injury and death reported to the FDA by patients crawling over, through and around the prior art “side rails”, in their traditional position, have become safety risks for clients with fragile physical body frames, and/or those with mental deficits such as seen in dementia.

As a further note, historically, certain issues have occurred with beds that articulate. The FDA has recognized that articulation of the bed introduces complex geometries that make applying dimensional criteria to reduce entrapment difficult. And like turn, in articulation of a bed (where the head portion raises about a longitudinal pivot axis along the medial region of the bed) such movement can create an additional array of issues with respect to potential entrapment of the bed occupant.

A growing percentage of the population is partially bedridden or otherwise requires a certain amount of assistance to travel. A well-known project in 1992 referred to as the Kunkel and Applebaum Project estimated that by the year 2020, 9.7 to 13.6 million older people will have moderate to severe disabilities.

Another factor related to providing a proper bedside support is the psychological effects of an individual with any form of medical problem to inhibit movement to and from a bed. Medical stability, cognitive function, patient motivation and duration of any disability may all modify the use of rehabilitation interventions or the goals of any form of rehabilitation (Kemp, 1990). In a like manner, the social psychological factors play a major role in a nursing home resident's willingness and ability to participate in self-care activities. In other words, research has shown that there is evidence to suggest that dependency in this population group is associated with certain mental health issues such as low self-esteem (Taft 1985; Blair 1992).

Therefore, given the need for devices to prevent entrapment zones, the increased number of individuals in society that may require a certain amount of assistance and the psychological effects not to mention the economic benefits of a certain amount of self-reliance contribute to the impending need for a proper device to accomplish these objectives.

### SUMMARY OF THE DISCLOSURE

The apparatus described below provides a safer alternative to the prior art departing from the teachings thereof and providing the swing-free mode without lateral entrapment zones. The apparatus is fixed at the right and/or left corners of the bed frame with a vertical bar that slides in and out of an attached sleeve. The bar is height adjustable, fixed at the position lengthwise to the bed, but freely swinging away from the bed to 90 degrees (in one form) intentionally pushed away by a caregiver or when a patient crawls off the side of the bed. This unfixed swing-free mode prevents entrapment between the rail and the mattress portions of the bed.

Individuals with cognitive impairment can grasp the bar when a caregiver directs them to hold the bar during turning and repositioning in bed. The system acts as a second caregiver in that it provides a means for the individual to exert their weight to the bar, thus saving a caregiver from using their body and averting the harm caused by back, neck and shoulder strain.

Individuals are able to participate in the repositioning and sitting up at the edge of bed as independent as possible which enhances their self image, range of motion activity and flexibility in the joints involved with bed mobility, transferring and standing. Further, facilities reap the potential financial benefit of decreased work related injury claims from less staff injuries. Facilities also potentially reap financial benefits in less State or Federal Citations for residents not achieving their highest level of physical function and they can experience less injuries in mentally impaired clients from entrapment in side rails. Such a system as described below can further satisfied family members as their loved ones improve.

The disclosure recites a bedside support device adapted to be positioned to a corner region of a bed structure. The bed structure has a lateral region and the bedside of the bed structure adapted to support an occupant thereon. The bedside support device has a mounting bracket that is adapted to be rigidly mounted to the corner region of the bed structure. The mounting bracket has a rotatable mount portion having a center rotation axis.

A support bar is further provided having a base region that is adapted to be mounted to the mounting bracket. The support rail has a handle region that is positioned orthogonally from the center rotation axis of the rotatable mount portion and the handle region is adapted to support a vertical load placed thereon. The handle region is adapted to rotate from a first position where the support handle is positioned adjacent to the lateral region of the bed structure to a second position away from the bed structure. the handle region defines an unobstructed lateral open area and the support handle.

The support handle has a free swinging mode where it can be repositioned from the first position to the second position by the occupant. The bedside rail is not positioned in the lateral region of the bed structure in a manner to allow the occupant to entrap themselves between the laterally outward region of the bed structure and the bedside support device when the bedside rail is in the free swinging mode.

### BRIEF DESCRIPTION OF THE DRAWINGS

FIG. 1 shows an orthogonal view of the bedside support device;

FIG. 2 shows a side view of the bedside support device;

FIG. 3 shows an orthogonal view from a laterally inward perspective of the mounting region where the securing mechanism is orientated inwardly;

FIGS. 4-7 show a progressive view of one mode of operating the bedside support device where FIG. 4 illustrates the device in a first position where the movement is restricted from going laterally inwardly and the individual can pull laterally inwardly thereon. FIG. 5 shows the individual positioned with her legs in the lateral unobstructed area where she is adapted to place a vertical force thereon and FIGS. 6 and 7 show the bedside support device in a free swinging mode where the handle region is adapted to swing laterally outwardly while providing support for the individual;

FIG. 8 shows a partial cross-sectional view where the pivot attachment member of the rotatable mount portion is shown;

FIG. 9 shows a partial sectional and exploded view of the various lower components of the bedside support device;

FIG. 10 shows a cross sectional view taken at line 10-10 of FIG. 8 where the pin is superimposed thereon illustrating the range of motion of the positioning slot having first and second stop surfaces adapted to engage the extension of the pin;

FIG. 11 shows a first embodiment of the base portion where a plurality of positioning slots are provided for height adjustment;

FIG. 12 shows a raise of positioning slots adapted to adjust the positional orientation of the handle and possibly the range of rotation of the handle by selecting the appropriate slot;

FIG. 13 shows a top view illustrating the various positions of the support bar with respect to the mounting region where this version alternatively shows a triangulating strengthening member;

FIG. 14 shows a view along line 14-14 of FIG. 13 where a sea channel-like mounting bracket can be employed;

FIG. 15 shows an alternative construction for the first and second members of the mounting bracket where an L-shaped angle iron is provided having the horizontal portion in the upper region;

FIG. 16 shows another variation of the mounting bracket or angle iron is employed and the horizontal portion is positioned downwardly;

FIG. 17 shows an alternative arrangement of the security mechanism where access thereto is provided in a laterally outward orientation;

FIG. 18 shows positioning the rotatable mount portion slightly longitudinally inwardly and positioned in the corner region;

FIG. 19 shows the bedside support device attached to an articulating bed where this figure illustrates how a side open region is substantially maintained without any shearing action between the bed and the handle region during the articulation of the bed;

### DETAILED DESCRIPTION OF THE EMBODIMENTS

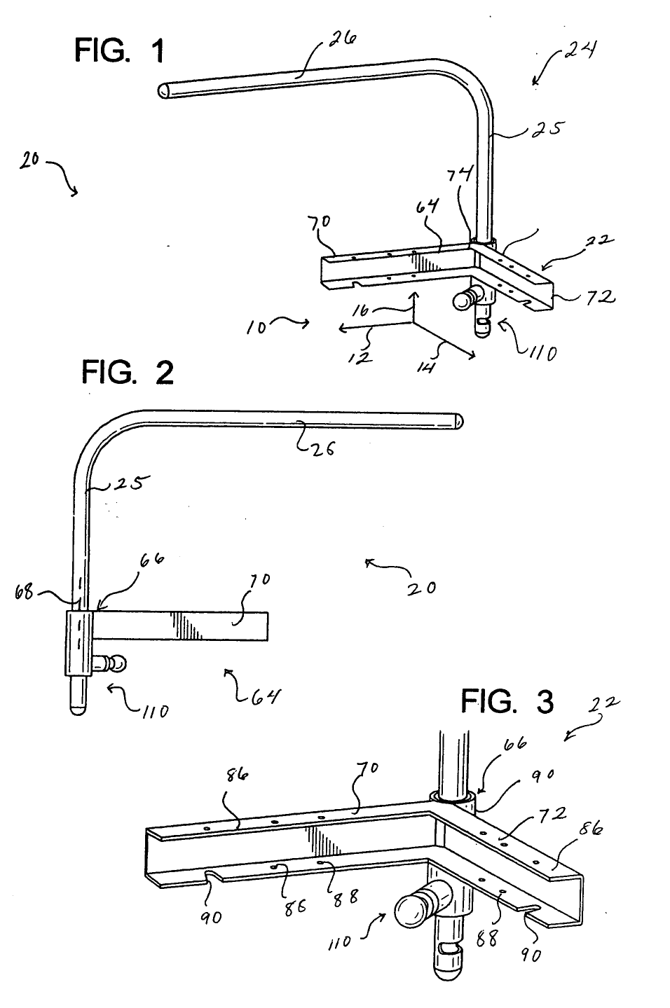

As shown in FIG. 1, the bedside support device 20 is shown in an isometric view in an assembled state not attached to a bed. To aid in the description, an axes system 10 is defined where the axis 12 indicates a longitudinal axis and the axis 14 indicates a lateral axis. Further, the axis substantially orthogonal to 12 and 14 is a vertical axis indicated at 16. The arrow indicating the lateral axis 14 points in a laterally inward direction where inward and outward are generally referenced from a longitudinal center region of the bed. The axis system is utilized to aid in the description of the various moving parts and orientation of components for a general direction and is not intended to limit the directional vectors to the exact orthogonal relationships shown in FIG. 1.

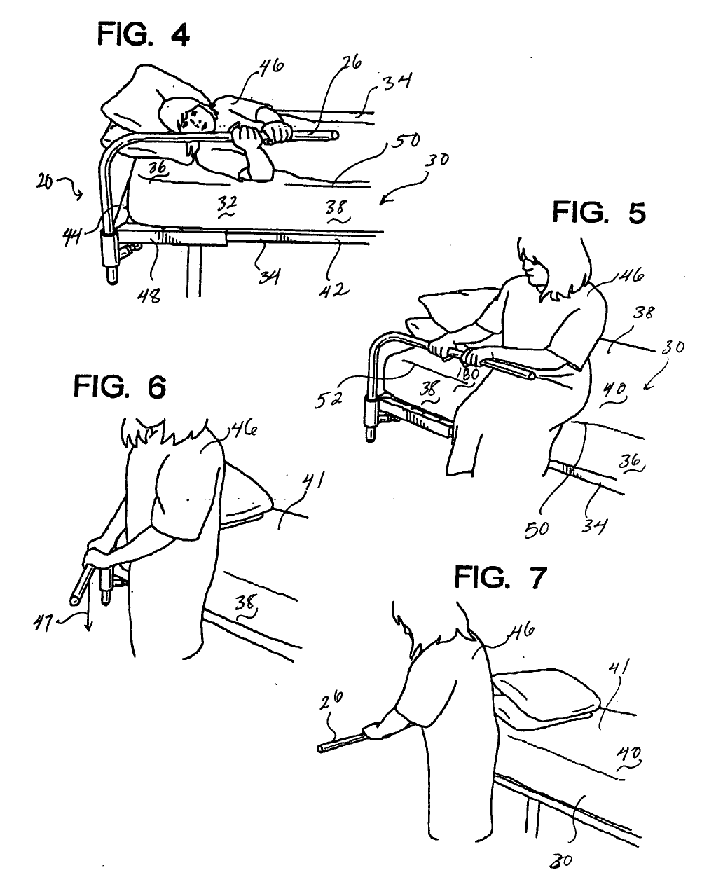

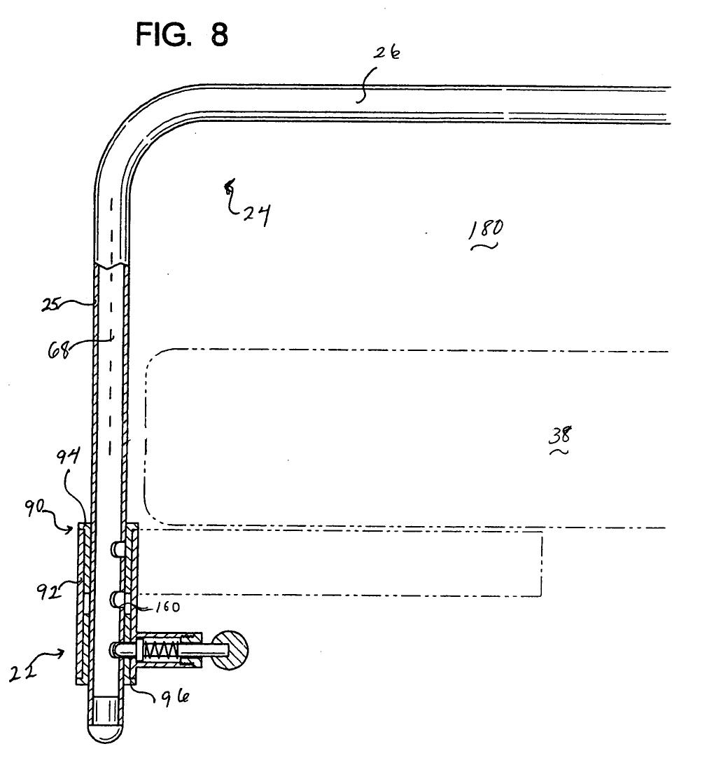

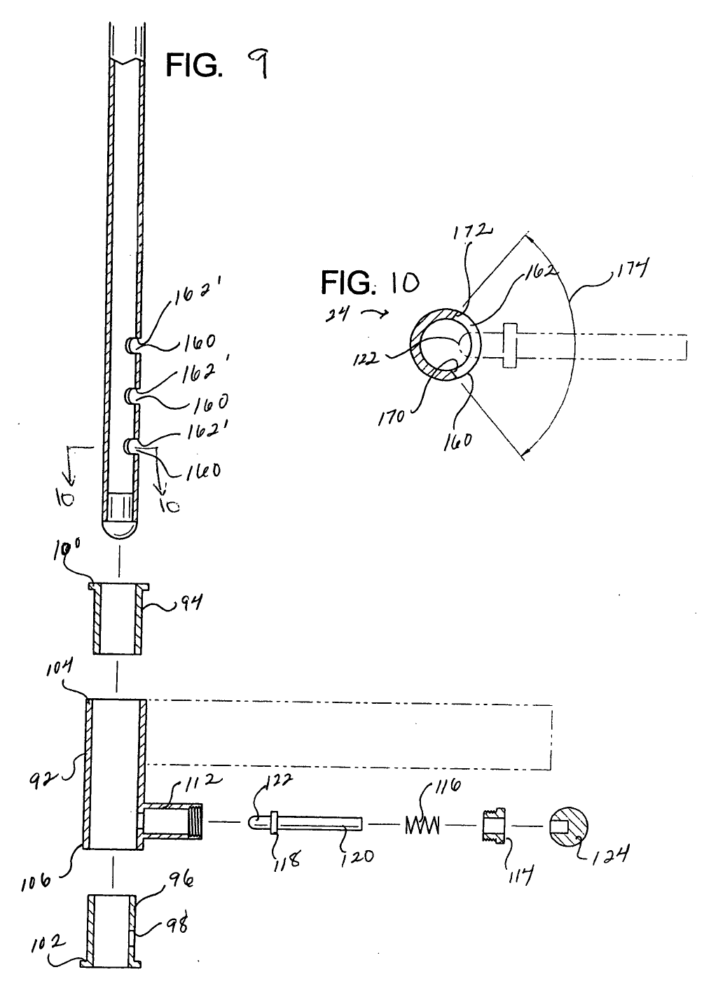

Briefly referring ahead now to FIG. 4 there will be a discussion of the overall environment of the bedside support device 20. As shown in FIGS. 4-7, the bedside support device 20 is adapted to be mounted to a bed structure 30. In most installations, the bed structure would comprise a bed and mattress 32 and a bed frame 34. The bed structure 30 has a head region 36, a longitudinally central region 34 and a foot region approximately shown at 36 in FIG. 5. The bed structure 30 further comprises laterally outward regions 38 and a lateral central region 40 as shown in FIG. 5. The bed frame 34 generally comprises longitudinally extending and laterally extending frame members 42 and 44 respectively. The frame members are generally rigid and sturdy to support the individual indicated at 46 in FIGS. 4-7. The bed frame generally defines a corner region 48 which is positioned at the head region 36 in the laterally outward region 38 of the bed structure 30. The laterally outward region 38 further defines a lateral mattress crest 50. The lateral mattress crest 50 is generally somewhat flexible as with most mattresses and, as described below, is used in part to define an open region, and on occasion this mattress crest is a potential liability for an entrapment zone. The term bed structure is defined broadly to cover various sleeping and resting platforms or other platforms that require a support device such as a medical exam type structures.

Referring now back to FIG. 1, the description will continue with the bedside support device 20. This isometric view shows the bedside support device comprising the mounting region 22 and the support bar/rail 24. In general, the mounting region which is adapted to be mounted in a number of methods as described below, essentially provides a pivotal attachment to the support bar 24. The support bar 24 is adapted to rotate about a substantially vertical axis and allow a handle region/member 26 to rotate in a substantially horizontal plane. The term “region” is defined broadly and encompasses both areas on unitary members where the handle region rotates with respects to the (static) base member. As described in further detail below, the various embodiments allow the flexibility to limit any potential entrapment zones.

The mounting region 22 as shown in FIG. 1 comprises a mounting bracket 64. The mounting bracket 64 is adapted to be rigidly mounted to the bed frame 34 at a corner region 48 as shown in FIG. 4. The corner region is broadly defined as an area on or adjacent to the bed structure which does not provide any substantial likelihood of entrapment zone by the base region 25. The mounting bracket has a rotatable mount portion 66 that is shown in FIG. 2 as a center rotation axis 68.

Referring back to FIG. 1, the mounting bracket 64 comprises a first member 70 and a second member 72. The first and second members 70 and 72 are fixedly attached at the juncture 74. In one form, these members 70 and 72 are permanently attached to one another in an orthogonal relationship and adapted to be fitted to the corner region 48 as shown in FIG. 4. In a preferred form, the mounting bracket 64 is constructed from a sufficiently strong material such as a metallic substance having a cross-sectional orientation such as channel iron or angle iron. Referring ahead now to FIGS. 20-23, there is shown a cross-sectional view of the first member 70 which also applies to the second member 72. FIG. 21 shows a C-channel like cross section that is adapted to encompass the upper and lower portions of the bed frame. Such a configuration is suitable for that frame having squared tubular steel members. The horizontal members 81 and 83 are adapted to be positioned above and below the horizontal square steel tubular members of the bed frame. FIGS. 22 and 23 show angle iron cross sections where the horizontal members 80 and 82 are adapted to either be positioned on the upper portion of the bed frame or to the lower portion of the bed frame respectively.

Referring back to FIG. 3, the first and second members 70 and 72 have mounting region 86 which in one form comprises a plurality of openings 88 or slots 90 that are adapted to correspond in location to existing openings in a bed frame. Of course there are a variety of bed frames on the market at the time of filing and in the future. In any form of mounting region which suitably rigidly attaches the mounting region 22 in a stable manner is within the scope of the invention. The rotatable mount portion 66 in one form comprises a pivotal attachment member 90 which in one form is a tubular sleeve 92 as shown in FIG. 8.

In a preferred form, the pivot attachment member 90 as shown in FIG. 8 and in the exploded sectional view FIG. 9, comprises upper bushing member 94 and lower bushing member 96. The bushing members 94 and 96 a commonly referred to as a bushing assembly and in the broader scope rotational mounting fixtures that can include any type of rotational type of mounting system such as bearings or the like. In a preferred form, a bushing assembly with a nylon type bushing comprising the members 94 and 96 is preferred because of the longevity of the bushings as well as the desirable coefficient of friction between the support bar 24 and the conical inner surface of the bearings 94 and 96. As shown in FIGS. 8 and 9, in one form the lower bushing member 96 comprises a surface defining the opening 98 which allows the extension of the securing mechanism 110 described immediately below. The bushing members 94 and 96 have upper and lower annular lips 100 and 102 respectively adapted to engage the upper and lower cylindrically planar surfaces 104 and 106 respectively. Of course it should be noted that a variety of methods can be employed to comprise a rotatable mount portion 66 to accomplish the task of allowing the support bar 24 to rotate about the center rotation axis 68 or the like.

The rotatable mount portion 66 further comprises a securing mechanism 110 as is best shown in FIG. 8 in partial sectional view. In one form, the securing mechanism is an adaptation of a conventional spring loaded pin system. As shown in FIG. 9, the securing mechanism 110 in a preferred form comprises a sleeve 112 that is rigidly attached to the tubular sleeve 92. The sleeve has a rearward portion that is attached to the cap 114 that provides a forward surface to bias the spring 116 against the annular lips 118 of the pin 120. The pin 120 has an extension 122 that is adapted to engage the various openings of the base region 25 of the support bar 24. The head 124 is adapted to be extracted outwardly from the sleeve 112 to withdraw the extension 122 inward and outward from the surface defined from the inner portion of the bushing members 94 and 96 to allow the base member to be repositioned vertically therein. Of course a variety of methods can be employed to operate as a securing mechanism 110 where in the preferred form, some form of an extension 122 extends within surfaces defining openings within the base region 25. As described further herein, another example of an embodiment is shown where the securing mechanism is attached to the handle region 26 and the base region 25 is essentially a static member with respect to the mounting bracket 64.

FIGS. 17 and 18 show various other embodiments where the rotatable mount portion 66′ is positioned in a different orientation where the securing mechanism 110″ is positioned outwardly for direct outward access by an individual. FIG. 18 shows a second embodiment whereby the rotatable mount portion 66″ is positioned somewhat longitudinally inwardly but still positioned substantially in the corner region away from the potential entrapment zones.

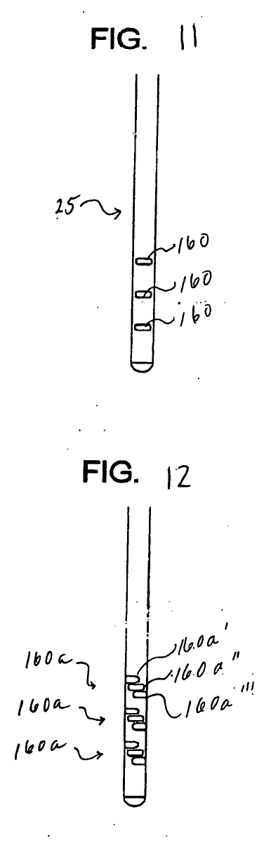

Referring now to FIG. 8, as shown in the lower portion of this figure, there is a plurality of positioning slots 160 where as shown in FIG. 10, the positioning slots 160 are defined by the partially annular surfaces 162 to essentially define an opening for the extension 122 to be placed therein. As shown in FIG. 9, the upper surface 162′ is adapted to resist the gravitational force of the support bar 24 as it rests upon the upper surface of the extension pin 122 as shown in FIG. 10. The positioning slot as shown in FIG. 10, has first and second stop surfaces 170 and 172 to position the handle region in a first and second position respectively as described below. The angle of rotation of the support bar 24 in one form is approximately 90 as indicated by angle 174 in FIG. 10. Of course a number of angular relationships can be employed where it is most desirable in a free swinging mode to have the handle region 26 be adapted to position laterally outwardly to prevent entrapment zones. In other words, a sufficient amount of lateral outward rotation is desirable to allow an individual 46 such as that as shown in FIG. 4 unwittingly roll out of bed without running the risk of being entrapped in any manner while the device is in a free-swinging mode.

In an alternate embodiment, the support bar 24, when in the lowered position, is configured to be temporarily locked or otherwise securely held in a position with the handle region 62 immediately adjacent to the bed. This configuration prevents or restricts the support bar's handle region from inadvertently moving away from the bed when the support bar 24 is in the lowered position. In one embodiment, the securing mechanism 46 can be used to engage the base region 60 (or extend through an aperture therein) when the support bar is in the lowered position to temporarily lock or otherwise hold the handle region 62 adjacent to the side of the bed.

In another embodiment, a collar or other projection can be provided on the base region 60 above the channels 48. The collar/projection can be a separate piece (e.g. collar) or an integral member (e.g. a nub) formed in the base region 60. The collar/projection has an outer diameter greater than the inner diameter of the pivot attachment member 26 so the collar/projection will prevent the base region of the support bar 24 from moving too far vertically through the pivot attachment member 26 relative to the bed 10. In one embodiment, the collar/projection can be positioned on the base region 60 at a location so that, when the support bar 24 is in the lowered position (preferably in the lowest height adjustable position with the handle region still above the surface of the bed), the collar/projection is adjacent to the pivot attachment member 26. In the embodiment that includes the collar/projection not integrally formed in the base region, the collar/projection can be attached to the support bar with fasteners, adhesive, friction fit, or a positive engagement (e.g., a peg screwed into the base region).

An example of the range of motion of the handle region 26 is shown in FIG. 13. As shown in this figure, the handle region is shown in the first position indicated at 26′ where the handle region is positioned adjacent to the laterally outward region 38 of the bed. It should be further noted that as shown in FIG. 8, the handle region 26 and the laterally outward region 38 define an unobstructed lateral open area generally indicated at 180 which prevents any entrapment zones in the lateral region of the bed which can be a hazard to impaired individuals. Referring ahead back to FIG. 13, the handle region further has a second position schematically indicated at 26″ and 26″ where the support handle is essentially positioned in the more distal location from the laterally outward region 38 of the bed. FIG. 13 further shows an optional triangulation member 71 adapted to reinforce the members 70 and 72.

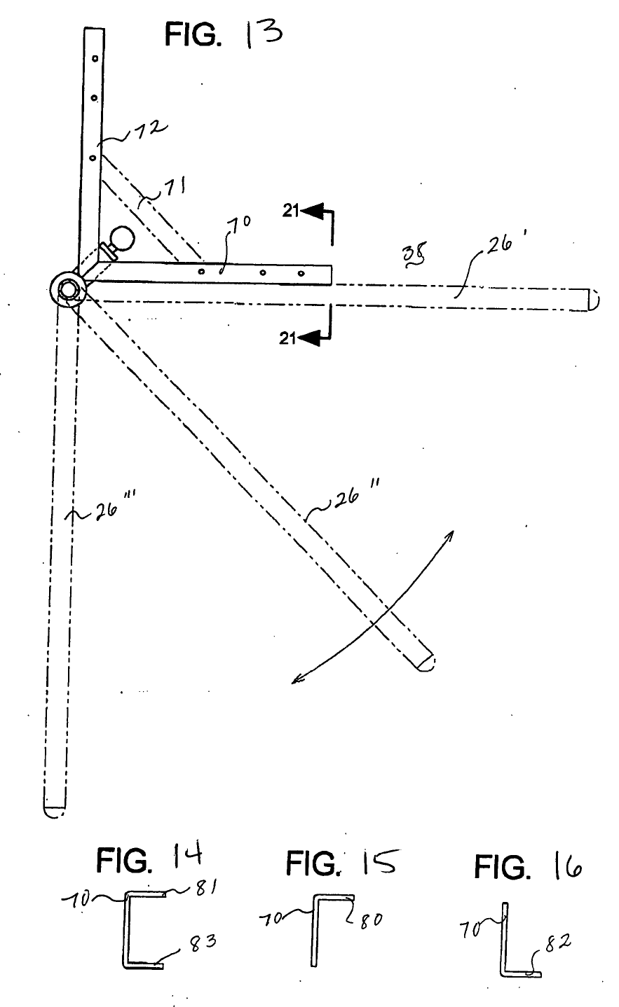

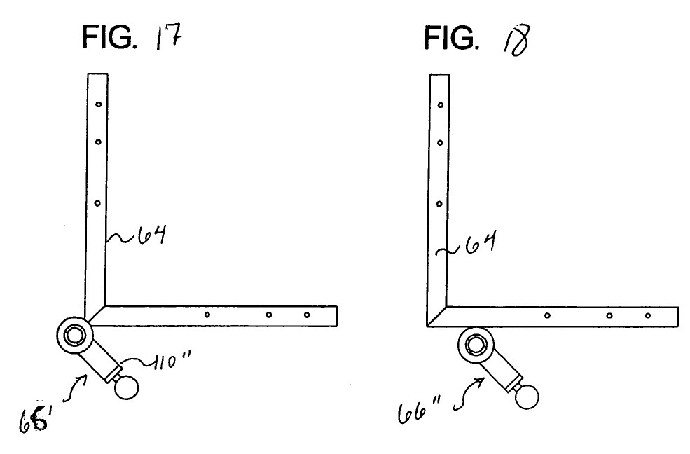

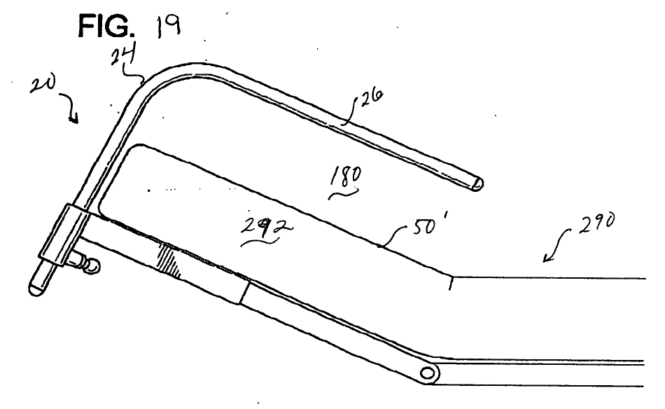

Referring now to FIGS. 11-12, there is shown various examples of base regions for the support bar. As shown in FIG. 11, the base region 25 comprises the openings described above, which include the positioning slots 160. When the bedside support device 20 is in an orientation as shown in FIGS. 4-7, there is no entrapment zone is in the lateral region because the bar would simply swing laterally outwardly while in a free swinging mode if the individual places any lateral force thereon (such as falling out of bed). A number of positioning slots 160 can be provided as is shown in FIG. 11 having lower middle and upper positioning slots to adjust the height for a proper ergonomic fit for the individual using the bedside support device 20. FIG. 19 shows the bedside support device 20 to that as shown in FIGS. 1-3 where the device 20 is attached to an articulating bed 290. FIG. 19 illustrates how the lateral unobstructed open area 180 is maintained during the articulation of the head portion 292 of the bed 290. The lateral mattress crest 50 maintains a positional relationship with the handle region 26 whereas to prevent any shearing action if there was relative vertical movement between the mattress head portion 292 and the support bar 24.

With the foregoing technical description in mind, there will now be a description of the apparatus as well as a method of using the same for assisting an individual in need 46. As introduced above, the individual 46 can represent a member of a variety of different classifications such as the elderly, an individual with temporary or permanent physical ailments, or individuals with cognitive impairments that are at risk of becoming entrapped and injured or any other individual who would require or desire such a device 20. Further, the setting for such a system can be in healthcare facilities such as hospitals or nursing homes as well as home use as well as any other area in need of such a device.

As shown in FIG. 4, the individual 46 is desirous of getting out of the bed structure 30 and is in the first stage of the process of grasping the handle member for its last region 26 with either one or both hands and placing a laterally inward force thereon. In this method of use, the handle region 26 resists the lateral inward torque for this is beyond the range of motion in this free-swinging mode of this embodiment. As shown in FIG. 10, the extension 122 is essentially engaging the stop surface 170 to prevent such an inward rotation. As shown in FIG. 5, the individual 46 can utilize the handle region 26 to pull herself substantially upright. To reiterate the functionality of the device, as shown in the left-hand portion of FIG. 5, the lines 39 and 41 define a plane substantially aligned in the vertical and longitudinal direction where any force applied on the side of the plane indicated by arrow 43 will be resisted by the support handle to allow a counterforce to be placed thereon for the benefit of the individual 46. In other words, the support handle provides a pulling surface to get over the edge of the bed and upright. Further, the individual can place her legs in the lateral unobstructed area generally indicated at 180 in FIG. 5. Not only does the laterally unobstructed area prevent an entrapment zone but further allows for the legs of the individual 46 to be placed therein. Now referring to FIG. 6, the individual 46 has stood up and can place a vertical force indicated at 47 thereupon the handle region 26. In this configuration, the handle region is in a free-swinging mode and allows free rotation/movement in the lateral direction. As shown in FIG. 7, the individual 46 has placed the handle region at a position away from the bed structure 30. In one form, the handle region can be positioned 90° of course various varieties of angles as illustrated at 174 in FIG. 10 can be employed by adjusting the stop surfaces. If the bed is in an open area and it is desirous to be not adjacent to the lateral outward region 38, the range of motion of the handle could for example be approximately 270° to wrap all the way around to the head portion of the bed perhaps behind a headboard or the like. Further, in one form, the first position is right adjacent to the bed in proximal location to the lateral medial crest 50 of the bed mattress 32 (see FIG. 4). However, various modifications to fit certain situations can be employed by adjusting the orientation of the stop surface 170 of FIG. 10 with respect to the position of the handle region 26. Of course, various modifications can be employed to the apparatus, and such other embodiments can be utilized in a similar fashion or other embodiments that could utilize a form of linkage-like system which is not confined to a static rotational axis.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A bedside support device adapted to be positioned to a corner region of a bed structure having a lateral region, the bed structure adapted to support an occupant thereon, the bedside support device comprising:
a. a mounting bracket adapted to be rigidly mounted to the corner region of the bed structure, the mounting bracket having a rotatable mount portion having a center rotation axis,
b. a support bar having a base region that is adapted to be rotatably mounted to the rotatable mount portion of the mounting bracket, the support rail having a handle region that is positioned orthogonally from the center rotation axis of the rotatable mount portion and the handle region is adapted to support a vertical load placed thereon and rotate from a first position where the support handle is positioned adjacent to the lateral region of the bed structure and defines an unobstructed lateral open area and the support handle is adapted to be positioned in a second position where the support handle is positioned in the more distal location from the laterally outward region of the bed structure,
c. whereas the support handle has a free swinging mode where it can be repositioned from the first position to the second position by the occupant and the bedside support device is not positioned in the lateral region of the bed structure in a manner to allow the occupant to entrap themselves between the laterally outward region of the bed structure and the bedside support device when the bedside support device is in the free swinging mode.

2. The bedside support device as recited in claim 1 where an extension pin is adapted to be movably mounting to the mounting bracket and is further adapted to engage a positioning slot of the base member.

3. The bedside support device as recited in claim 2 whereby the positioning slot extends around the center rotation axis of the mount portion to provide and limit the range of motion of the support handle.

4. The bedside support device as recited in claim 3 whereby a plurality of positioning slots are positioned along the base member to provide a height adjustment of the support handle.

5. The bedside support device as recited in claim 1 where the rotatable mount portion comprises a first and second bushing member positioned at lower and upper regions of the rotatable mounting portion.

6. The bedside support device as recited in claim 5 whereby the rotatable mounting portion comprises a tubular sleeve adapted to mount the first and second bushing members.

7. The bedside support device as recited in claim 1 where the mounting bracket is adapted to be positioned to the frame of the bed structure and move therewith if the bed structure is an articulating bed.

8. A method for providing mobile assistance to an occupant of a bed structure comprising the steps of:
a. positioning a bracket rigidly to a portion of the bed structure and having a support rail be rotatably mounted to the bracket,
b. having the support rail positioned in a manner where a support handle of the support rail is positioned adjacent to the bed structure in a position adjacent to a lateral medial region of the bed that allows the legs of the occupant to be positioned thereunder the support rail,
c. the support handle adapted to be freely rotated in a laterally outward direction with respect to the lateral region of the bed structure by having the support rail in a free swinging mode,
d. providing a support handle of the support rail which is adapted to resist a load placed thereon by the occupant of the bed structure whereby the occupant places a force upon the support handle and lifts their body from the lateral region of the bed structure with the legs positioned under the support handle while standing and the occupant can walk away from the bed structure where the support handle repositions in a laterally outward direction with the occupant.

9. The method as recited in claim 8 whereby the support handle resist rotation at lateral location of the bed so the occupant can place a laterally inward forced thereon.

10. The method as recited in claim 8 where the support handle has an inward portion and an outward portion where the occupant can grab either portion for assisting themselves into an upright position in a lateral portion of the bed structure.

11. The method as recited in claim 9 above where the support handle resist rotation passed a laterally outward location near a lateral mattress crest of the bed structure.

12. The method as recited in claim 9 where the support rail comprises a static base region fixedly attached to the corner region of the bed structure and the support handle of the support rail swings there about the static base region.

13. A method of providing bedside assistance for an individual in need of support to get out of a bed structure, the method comprising:
a. positioning a rotatable mount portion to a corner region of a bed structure in a sturdy manner so the rotatable mount portion is adapted to handle a moment placed thereon about an axis in a substantially horizontal plane,
b. positioning a handle region in the corner region of the bed structure and rotatably mount the handle region to the rotatable mount portion,
c. providing a free-swinging mode of the handle region where the handle region is adapted to be orientated in a first position adjacent to a laterally outward region of the bed structure and defining an open area between a lateral mattress crest of the mattress and the handle region,
d. providing restricted movement of the handle region where the region is adapted to resist rotation laterally inward with respect to the mattress to provide a laterally inward force exerted thereon by the individual,
e. allowing the individual to place a laterally inward force upon the handle to aid in positioning the individual toward the lateral outward region of the bed structure where the individual's legs are positioned in the open area between the lateral mattress crest and the handle region,
f. providing sufficient vertical resistance to force upon the handle with minimal movement where the individual can place a downward force upon the handle and the legs of the individual are situated in a manner where the individual can stand and allow the handle to reposition from said first position to a laterally outward position in a free-swinging mode.

14. The method as recited in claim 13 where the rotatable mount portion is attached to a mounting bracket that is rigidly attached to a frame of the bed.

15. The method as recited in claim 14 where the rotatable mount portion is attached to a static base region that extends vertically from the mounting bracket.

16. The method as recited in claim 13 whereby the handled region is restricted in rotation by a securing mechanism having an extension that is adapted to engage a positioning slot.

17. The method as recited in claim 13 whereby the handle region is part of a support bar and further comprises a base region which is adapted to be rotatably mounted within the rotatable mount portion.

18. The method as recited in claim 17 where the base region comprises a positioning slot that comprise first and second stop surfaces to limit the range of rotation of the handle region with respect to the rotatable mount portion.

19. The method as recited in claim 18 where its plurality of positioning slots are provided to adjust the height of the handle region with respect to the bed.

20. The method as recited in claim 13 whereby the handle region is adapted to be positioned at approximately 90° from the first position.

21. The method as recited in claim 13 whereby the handle region is adapted to rotate about a center rotation axis at least 90° with respect to the rotatable mount portion to provide assistance for the individual as the individual walks away from the bed.

22. The method as recited in claim 19 of claims above whereby the securing mechanism is positioned underneath the bed structure to not promote adjustment thereof.

23. A mobile bedside assistant device for a structure adapted to have an individual lie prone, the mobile bedside assistant device comprising:
a handle region positioned orthogonally from a center rotation axis, the handle region having an inward portion toward the center rotation axis and adapted to rotate about the center rotation axis, the center rotation axis being adapted to be orientated in a longitudinal head portion and lateral portion of the structure adapted to have an individual lie prone, the handle region being adapted to freely swing about the center rotation axis in a free-swinging mode and further adapted to resist rotation laterally inwardly at a defined location, the handle region being orientated in a manner with respect to the structure adapted to have an individual lie prone to provide a zone that is substantially open and adapted to have legs of an individual occupying the bed structure be positioned thereunder as the individual sits in the lateral region of the structure, the handle region being adapted to resist vertical force placed thereon and allow rotation for movement of the individual away or to the bed structure.

24. A system for providing access to a bed structure for an individual in need of assistance, the system comprising:
a support handle rotatably mounted to a corner region of a bed structure, the support handle having a free-swinging mode to allow motion of the support handle from a first position adjacent to the bed structure to a second position away from the bed structure, the support handle being adapted to support downward force thereon without impeding the free rotationability of the support handle in the defined range, the defined range of the support handle having one extreme orientation where the support handle is in the first position and is adapted to have laterally inward force placed thereon, the support handle orientated in a manner to define a lateral open region in the bed structure.

25. The system as recited in claim 24 whereby the lateral open region has a sufficient height to allow the legs of an individual placed therein.

26. The system as recited in claim 24 whereby the support handle is adapted to have the weight of an individual placed thereon while providing movement in the lateral direction.

27. The system as recited in claim 26 whereby the movement of the support handle is rotational about a center rotation axis.

28. The system as recited in claim 27 whereby the support handle is attached to a base region which is rotatably mounted to a rotatable mount portion that is attached to a mounting bracket which in turn is attached to the corner region of a bed structure.

29. The system as recited in claim 24 whereby the potential for entrapment zones are not present in laterally outward region of the bed structure.

30. The system as recited in claim 28 whereby the rotatable mount portion comprises a securing mechanism that is adapted to engage positioning slots of the base region.

31. The system as recited in claim 30 whereby the positioning slots have first and second stop surfaces that are adapted to engage an extension which is rotatably fixed to the rotatable mount portion to limit the amount of rotational travel of the support handle.

32. The system as recited in claim 31 whereby the securing mechanism is a spring-loaded pin that is adapted to extend underneath the bed structure.

33. The system as recited in claim 32 above whereby the mounting bracket is comprised of a channel first member and a channel second member intersecting at a juncture point.

34. The system as recited in claim 24 whereby the support handle is attached to a base region which is attached to a bedside fixture.

35. The system as recited in claim 31 whereby the mounting bracket is attached to an articulating bed structure and the support handle is adapted to be repositioned with a head region of the bed structure.

36. The system as recited in claim 24 whereby the support handle is rotatably attached to static base region that is fixedly attached to a mounting bracket which is attached to the corner region of a bed structure.

37. The system as recited in claim 24 whereby the support handle is attached to a base region which is rotatably mounted to a base bracket on either left or right corner regions of a bed structure.
